(19) United States
(12) Patent Application Publication
(10) Pub. No.: US 2005/0046529 A1
(43) Pub. Date: Mar. 3, 2005

(54) Closed type on/off-switching device

(76) Inventor: Chih-Lin Jao, Miao-Li Hsien (TW)

Correspondence Address: SUPREME PATENT SERVICES, POST OFFICE BOX 2339, SARATOGA, CA, 95070, US

(21) Appl. No.: 10/763,669

(22) Filed: Jan. 24, 2004

(30) Foreign Application Priority Data
Sep. 4, 2003 (CN) 03 2 74270.3
Sep. 2, 2003 (CN) 03 2 74221.5

(51) Int. Cl. H01H 9/00

(52) U.S. Cl. 335/205

(57) ABSTRACT

A closed type on/off-switching device includes a casing, an insulating plate in the casing, a power source, a vibration switch, and a power-consuming element on the insulating plate, a circular guiding frame on the inner wall of the casing, a magnetic conductive block movable up and down in a cavity formed by the circular guiding frame, a pair of separated jumpers at positions corresponding and opposite to the magnetic conductive block for being bridged by the magnetic conductive block, and a magnetic control block located on the transparent plastic casing and separated from the magnetic conductive block inside the casing for attracting the latter to depart from the pair of separated jumpers to thereby cut off the circuit and prevent any misuse of the power source accordingly.

### BACKGROUND OF THE INVENTION

1. Field of the Invention

The present invention relates to an on/off-switching device, and it relates specifically to a closed type waterproof on/off-switching device capable of preventing a circuit from misusing the power source.

2. The Prior Arts

Following to the heightening delights of life, many products with respective practical functions in combination with an entertainment effect have been presented to the market. For example, an on/off-switching device is an electric circuit comprising a power source, a vibration switch, and a power-consuming element, which could be a color-indicator light or a music integrated circuit (IC) card. Such an on/off-switching device is now widely applied to household articles, arts and crafts, and toys.

When a mentioned article is triggered to start vibrating, the vibration switch in the on/off-switching device is supposed to connect with the power source and give a color light or beautiful music. However, the power source box of the on/off-switching device is usually unsealed so that it is not waterproof and is liable to get leaked or short-circuited. Moreover, a commodity equipped with a conventional on/off-switching device may accidentally activate the circuit in a conveyance process, or exhibition, or in an unexpected bump to hence undesirably exhaust the power source.

Therefore, in order to avoid undesired power consumption, the direct current (DC) power source, a battery for example, is usually isolated when a commodity mentioned is out of use by inserting an insulating piece in the space between the battery and the circuit, and it is simply to remove the insulating piece when using the commodity is desired. Unfortunately, however, in the event of a sealed waterproof construction, the conventional method of inserting an insulating piece for preventing misuse of power does not work.

### SUMMARY OF THE INVENTION

The primary object of the present invention is to provide a closed type on/off-switching device for preventing misuse of the power source and improving the waterproof of the existing switching device.

In order to realize above object, the closed type on/off-switching device of the present invention comprises: a casing; an insulating plate in the casing; a power source, a vibration switch, a power-consuming element on the insulating plate; a circular guiding frame on the inner wall of the casing; a magnetic conductive block movable up and down in a cavity formed by the circular guiding frame; a pair of separated jumpers at positions corresponding and opposite to the magnetic conductive block for being bridged by the magnetic conductive block; and a magnetic control block located on the transparent plastic casing and separated from the magnetic conductive block inside the casing for attracting the latter to depart from the pair of separated jumpers. The vibration switch, the power-consuming element, and the pair of jumpers are cascaded in series with the power source.

According to one aspect of the closed type on/off-switching device of the present invention, the insulating plate is a circuit board, and the power source and the vibration switch are arranged on one side of the circuit board while the power-consuming element and the jumpers on the other side.

According to another aspect of the closed type on/off-switching device of the present invention, the power source is a button cell, and the casing is a transparent plastic housing.

According to yet another aspect of the closed type on/off-switching device of the present invention, the power-consuming element could be a color light emitting diode (LED), auto-flash color LED, combination of music IC chip and sounding element, combination of color LED and music IC chip and sounding element, or combination of auto-flash color LED and music IC chip and sounding element.

According to yet another aspect of the present invention, the on/off-switching device is a closed-type waterproof construction, in which a protective mechanism is cascaded in series with the vibration switch so that the magnetic control block could be put on the casing at a proper position to attract the magnetic conductive block to depart from the jumpers to thereby cut off the circuit when shutdown of the power-consuming element is desired during conveyance. On the contrary, the magnetic control block is removed so that the magnetic conductive block would drop down to bridge the jumpers and activate the circuit to work.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a cutaway sectional view of a closed type on/off-switching device of the present invention;

FIG. 2 is a top view of an insulating plate shown in FIG. 1;

FIG. 3 shows the circuit of a first embodiment of the closed type on/off-switching device of the present invention;

FIG. 4 is a cutaway sectional view showing an embodiment of a nozzle equipped with the closed type on/off-switching device of the present invention;

FIG. 5 shows the circuit of a second embodiment of the present invention; and

FIG. 6 shows the circuit of a third embodiment of the present invention.

### DETAILED DESCRIPTION OF THE PREFERRED EMBODIMENT

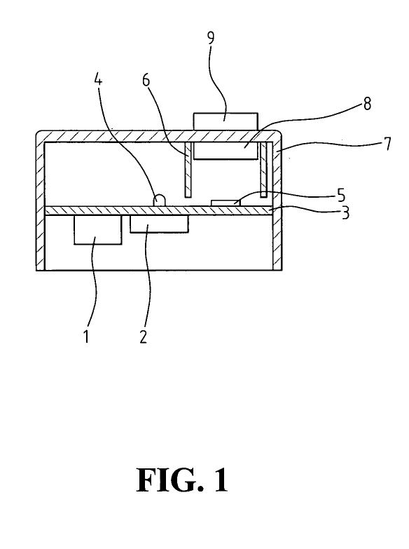

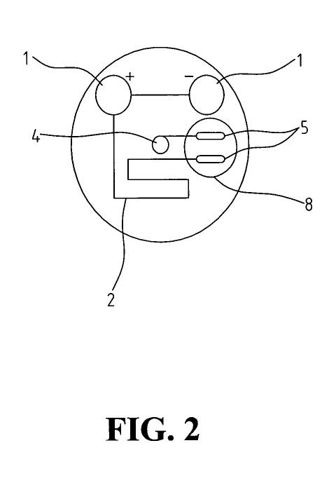

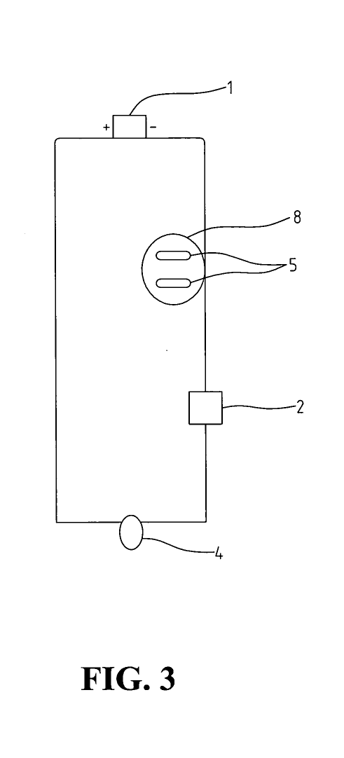

As shown in FIGS. 1-3, a closed type on/off-switching device in accordance with the present invention is comprised of: a casing 7; an insulating plate 3 disposed in the casing 7; a power source (button cell) 1 and a vibration switch 2 arranged on one side and a power-consuming element 4 on the other side of the insulating plate 3; a circular guiding frame 6 disposed on the inner wall of the casing 7, and a magnetic conductive block 8 movable up and down in a cavity formed by the circular guiding frame 6; a pair of separated jumpers 5 disposed at positions corresponding and opposite to the magnetic conductive block 8 for being bridged by the magnetic conductive block 8; and furthermore, a magnetic control block 9 of a first embodiment of the present invention being located above and separated from the magnetic conductive block 8 by the transparent plastic casing 7 for attracting the magnetic conductive block 8 to depart from the pair of separated jumpers 5, in which the vibration switch 2, the power-consuming element 4, the pair of jumper 5, and the power source 1 are cascaded in series as shown in FIG. 3.

One surface of the magnetic conductive block 8 is a conductive surface to bridge and conductively connect the jumpers 5 together, and the other surface of the magnetic conductive block 8 is arranged for being attracted by the magnetic control block 9 to depart from the jumpers 5. The power-consuming element 4 could be any of a color LED, a music IC chip, a sounding element, a combination of sounding element or color diode together with music IC, or a combination of auto-flash color diode and music IC. When the magnetic control block 9 is placed on the casing 7 at a position corresponding to that of the magnetic conductive block 8 inside the casing 7, the magnetic control block 9 would attract the latter to depart from the jumpers 5 to hence disable the circuit and thereby prevent an undesirable misuse of the power source; on the contrary, for service operation, the magnetic control block 9 is removed to release and drop the magnetic conductive block 8 so that the circuit is activated. Such a mechanism of closed type on/off-switching device is excellent in waterproof and effective in prevention of misusing the power source.

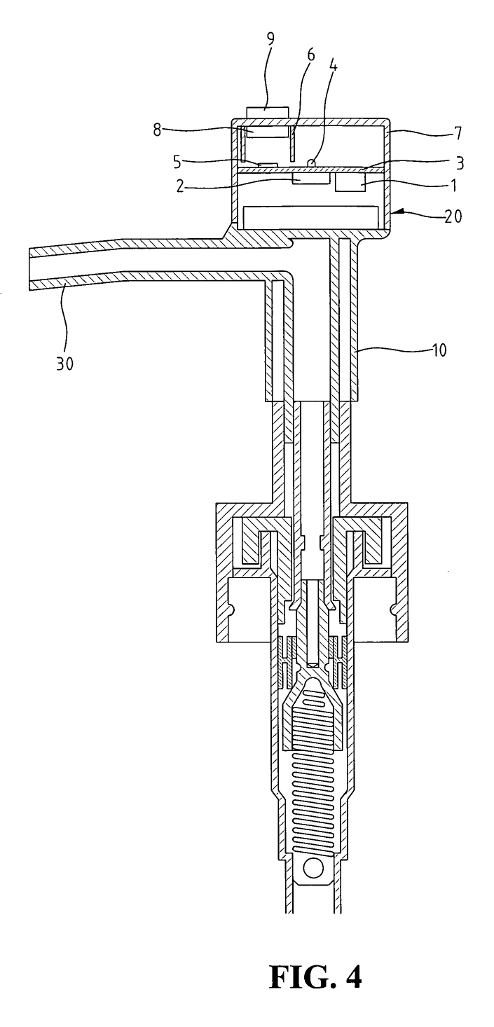

FIG. 4 is a cutaway sectional view showing an embodiment of a nozzle equipped with the closed type on/off-switching device of the present invention. The nozzle is provided with a depression grip 10 and a liquid-drawing device of liquid bottle. A user may draw liquid (emulsion) from the bottle by pressing down the depression grip 10, then, outputting the liquid through an outlet 30. In this embodiment, the closed type on/off-switching device is combined to a top end of the depression grip 10 to therefore meanwhile perform an extra acousto-optical effect for entertainment when the depression grip 10 is pressed down.

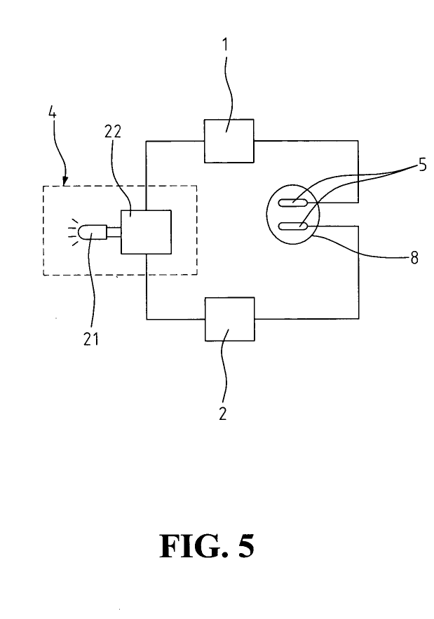

FIG. 5 shows the circuit of a second embodiment of the present invention, which adopts an LED acousto-optical circuit comprised of an LED 21 and a circuit chip 22 for driving the LED 21 to flash, in which the chip 22 could be a chip made by the available technology so far.

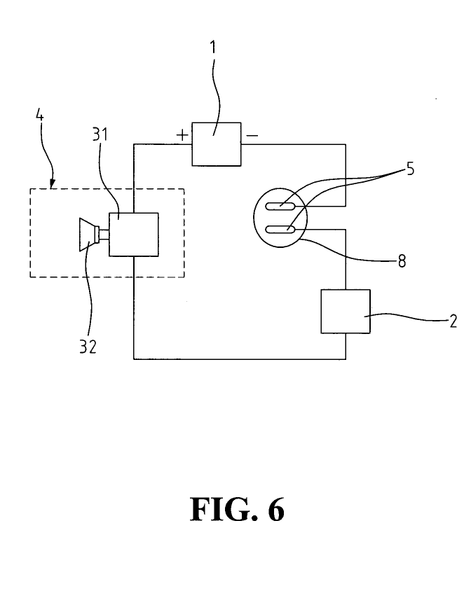

FIG. 6 shows the circuit of a third embodiment of the present invention, in which an acousto-optical circuit is adopted comprising a music IC chip 31 by cascading a power source and a vibration switch 2 in series and a sounding element 32, such as a buzzer or a speaker, driven by the IC chip 31 which could be an existing music chip obtainable in the market today.

The magnetic control block 9 shouldn't be placed on the casing 7 on service, and the lighting circuit shown in FIG. 5 or the sounding circuit shown in FIG. 6 will be triggered to work by vibration. When out of service is required, in a conveyance process for example, the magnetic control block 9 is supposedly placed on the casing 7 at a position corresponding to that of the magnetic conductive block 8 inside the casing 7 to attract the magnetic conductive block 8 up and depart from the pair of jumpers 5 and thereby disconnect the circuit accordingly. On the contrary, the magnetic control block 9 is removed from the casing 7, so that the magnetic conductive block 8 is released and dropped to connect both the jumpers 5 and activate the circuit. And at this time if the nozzle is pressed down, the vibration will trigger the vibration switch 2 to make the power source available, so that color light or beautiful music can be performed for people to enjoy.

In the above described, at least one preferred embodiment has been described in detail with reference to the drawings annexed, and it is apparent that numerous changes or modifications may be made without departing from the true spirit and scope thereof, as set forth in the claims below.

1. A closed type on/off-switching device, which comprises a closed casing having an insulating plate and a magnetic conductive block inside, as well as a magnetic control block outside, being capable of controlling on/off action depending on the interactions between the magnetic conductive block and the magnetic control block.

2. The closed type on/off-switching device according to claim 1, wherein a power-consuming element, a power source, a pair of separated jumpers being disposed on the insulating plate, the magnetic conductive block being arranged striding and bridging the jumpers to thereby build a circuit for the power-consuming element, the magnetic control block attracting the magnetic conductive block from outside of the closed casing to hence make the magnetic conductive block depart from the jumpers and thus cutting the circuit off.

3. The closed type on/off-switching device according to claim 2, wherein the insulating plate comprises a vibration switch.

4. The closed type on/off-switching device according to claim 2, wherein a guiding frame disposed in an inner wall of the casing comprises a cavity for the magnetic conductive block to move up and down.

5. The closed type on/off-switching device according to claim 2, wherein the insulating plate is a circuit board; the power source and the vibration switch being disposed on one side of the circuit board while the power-consuming element on the other.

6. The closed type on/off-switching device according to claim 2, wherein both the power-consuming element and the separated jumpers are disposed on one side of the circuit board.

7. The closed type on/off-switching device according to claim 2, wherein the power source is a button cell.

8. The closed type on/off-switching device according to claim 1, wherein the casing is a transparent plastic housing.

9. The closed type on/off-switching device according to claim 2, wherein the power-consuming element is a color light emitting diode.

10. The closed type on/off-switching device according to claim 2, wherein the power-consuming element is an auto-flash color light emitting diode.

11. The closed type on/off-switching device according to claim 2, wherein the power-consuming element comprises a music integrated circuit chip and a sounding element.

12. The closed type on/off-switching device according to claim 2, wherein the power-consuming element comprises a color light emitting diode, a music integrated circuit chip, and a sounding element.

13. The closed type on/off-switching device according to claim 2, wherein the power-consuming element comprises an auto-flash light emitting diode, a music integrated circuit chip, and a sounding element.
